(19) United States
(12) Patent Application Publication
(10) Pub. No.: US 2005/0254359 A1
(43) Pub. Date: Nov. 17, 2005

(54) Optical pickup

(76) Inventors: Aik Seng Yak, Singapore (SG); Pei Chin Won, Singapore (SG); Tuck Leong Lim, Singapore (SG); Gurdev Singh, Singapore (SG)

Correspondence Address: PHILIPS INTELLECTUAL PROPERTY & STANDARDS, P.O. BOX 3001, BRIARCLIFF MANOR, NY, 10510, US

(21) Appl. No.: 10/510,781

(22) PCT Filed: Apr. 9, 2003
(86) PCT No.: PCT/IB03/01447

§ 371 Date: Oct. 12, 2004

(30) Foreign Application Priority Data
Apr. 17, 2002 (WO) PCT/SG02/00075

(51) Int. Cl. G11B 7/00

(52) U.S. Cl. 369/44.23; 369/44.27; 369/44.41

(57) ABSTRACT

An optical disc drive (I) comprises an optical pickup (3) with a 4-quadrant photo-detector (20); an objective lens (14) mounted displaceably with respect to the photo-detector (20); an optical displacement actuator (30) for displacing the objective lens (14); and a servo controller (70) for controlling the focus actuator (30). The controller (70) receives respective detector signals (S1, S2, S3, S4) from the photo-detector (20). The controller (70) is adapted to process these detector signals to produce a focal error signal (FE) which is zero if these signals all have identical magnitude. The controller (70) is further adapted to subtract/add an offset parameter (?_{off}) from/to said focal error signal (FE), and to provide the difference/sum as a control output signal.

The present invention relates in general to an optical pickup in an optical system for writing information into an optical storage medium and/or for reading data from an optical storage medium. Examples of such storage media are, for instance, CD-ROM, CD-R, CD-RW, DVD, etcetera. In these examples, the optical storage medium has the shape of a disc.

As is well known in the art, an optical disc comprises at least one track which is capable of containing data written therein. The disc may be embodied so as to be a read-only disc: the disc is manufactured with data recorded in the track, and this data can only be read from the disc. However, writeable optical discs allowing a user to record data on a disc are also known; in this case, a disc will normally be manufactured as a blank disc, i.e. a disc having a track structure but without data recorded in the track.

Disc drive devices may be designed as read-only devices, i.e. devices only capable of reading information from a recorded disc. However, disc drive devices may also be designed for writing information into the track of a recordable disc.

Since optical discs, and disc drive devices for reading or writing optical discs, are commonly known, it is not necessary here to discuss their operation in more detail.

In all cases, a disc drive device comprises means for receiving an optical disc and for rotating the optical disc at a predetermined rotational speed. The disc drive device further comprises an optical head or optical pickup, comprising a light beam generator, typically a laser, for directing a laser beam towards the surface of the rotating disc, for receiving the reflected beam reflected by the disc, and for converting the received reflected beam into an electrical signal. Thus, an optical pickup comprises a light beam generator, an optical system for directing the light beam towards the optical disc, a photo-detector for converting light into an electrical signal, and an optical system for receiving reflected light and for directing this reflected light towards the photo-detector. The optical system is capable of focusing the light beam on the track of the optical disc, and is further capable of focusing the received reflected light beam on the photo-detector. The optical system is displaceable along the optical axis (z-direction) in order to be able to compensate for variations in optical path length. A servo system associated with this optical lens system is adapted to maintain the required focusing.

A problem with optical pickups is that the photo-detector must be positioned very accurately with respect to the light beam. The tolerance for the position of the photo-detector in the z-direction is in the order of about 100 μm. The tolerance in directions perpendicular to the z-direction (x-direction: radial direction; y-direction: track direction) is in the order of 10 μm. It is very difficult to achieve this positioning accuracy when manufacturing an optical pickup. It is further very difficult to guarantee that this positioning accuracy is maintained during the lifetime of the optical pickup, taking into account that the optical pickup may suffer from temperature variations and from temperature shock and/or mechanical shock. If the photo-detector is not positioned within the required tolerances, the playability of discs is affected, and it may even be that the optical pickup is to be rejected.

An important objective of the present invention is to reduce this problem. Particularly, an objective of the present invention is to provide an optical pickup which is improved in that the tolerance restraints for the photo-detector are reduced.

More particularly, an objective of the present invention is to provide an improved controller for the servo system of the optical pickup, which is programmed (software) such that the optical pickup is less sensitive to positioning errors of the photo-detector.

In order to attain these objectives, an optical pickup according to the present invention is designed to add a focal offset to the optical beam. Surprisingly, it has been found that this focal offset makes the pickup less sensitive to positioning errors of the photo-detector.

These and other aspects, features and advantages of the present invention will be further explained by the following description of a preferred embodiment of an optical pickup according to the present invention with reference to the drawings, in which same reference numerals indicate same or similar parts, and in which:

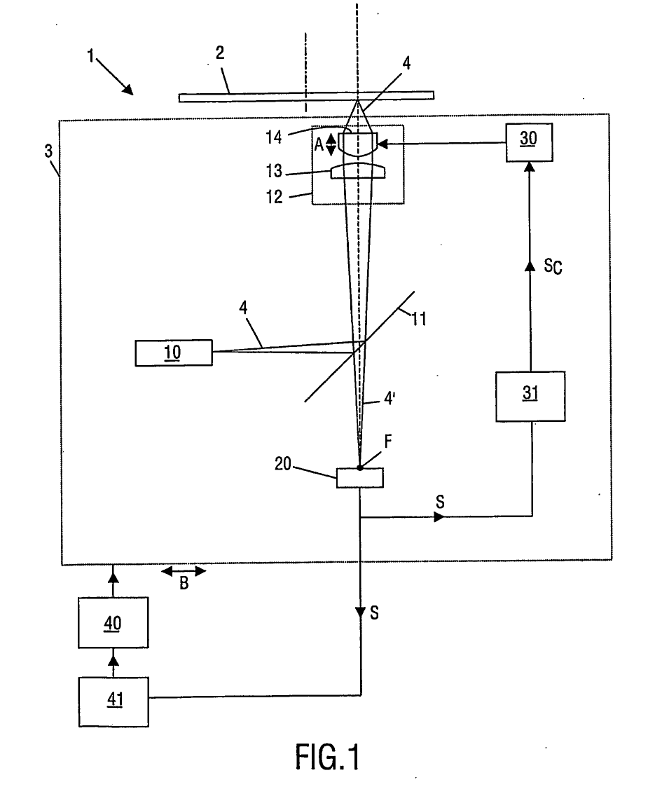

FIG. 1 schematically illustrates an optical disc drive;

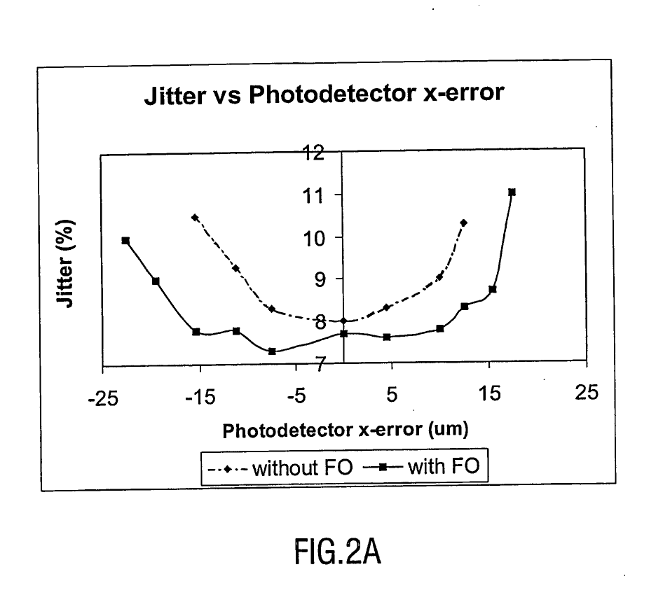

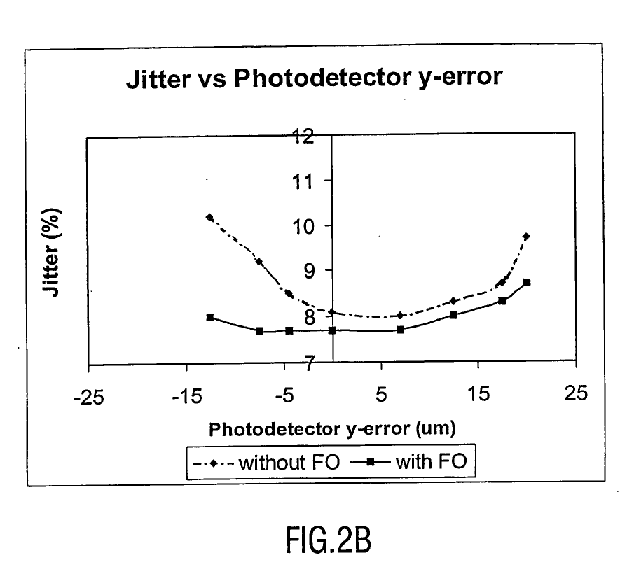

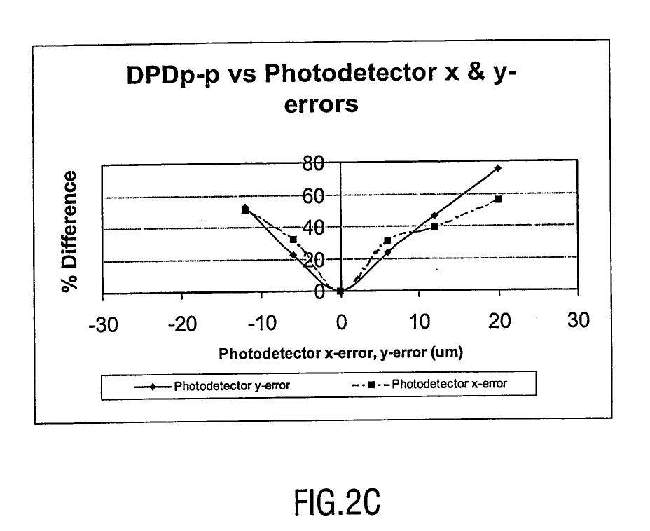

FIGS. 2A-C are graphs showing the results of measurements of jitter and DPD_{PP} versus positioning error;

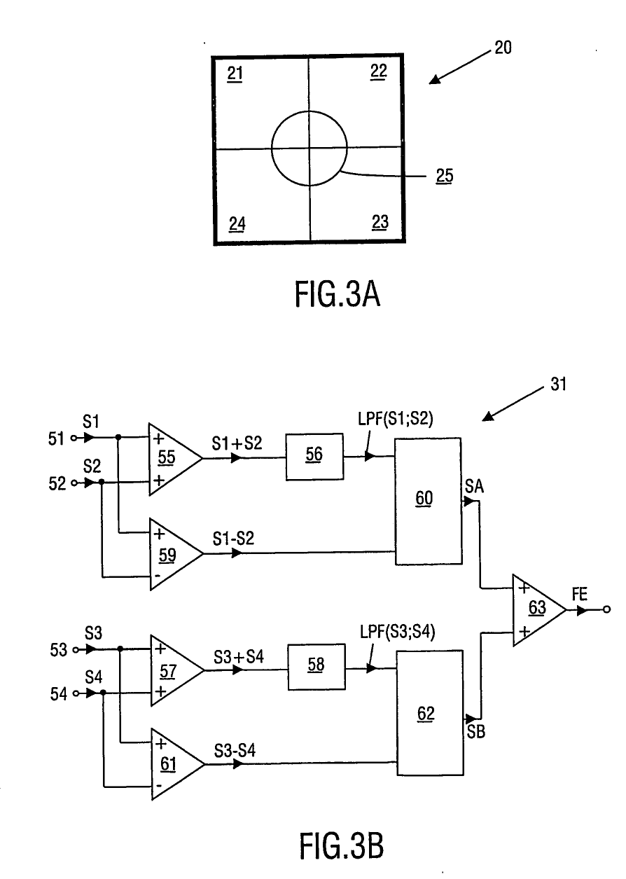

FIG. 3A is a view illustrating a 4-quadrant photo-detector;

FIG. 3B is a schematic block diagram illustrating a prior art embodiment of a controller;

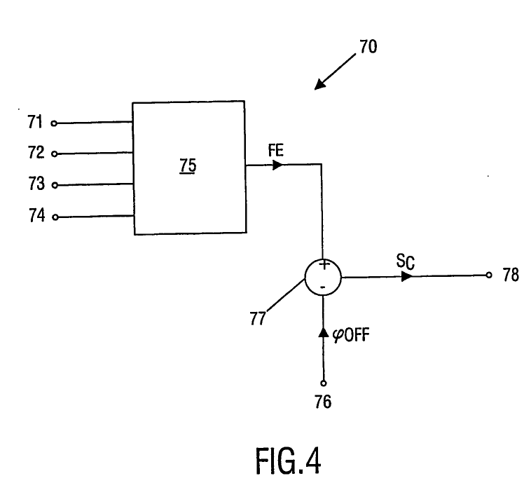

FIG. 4 is a schematic block diagram illustrating an embodiment of a controller according to the present invention;

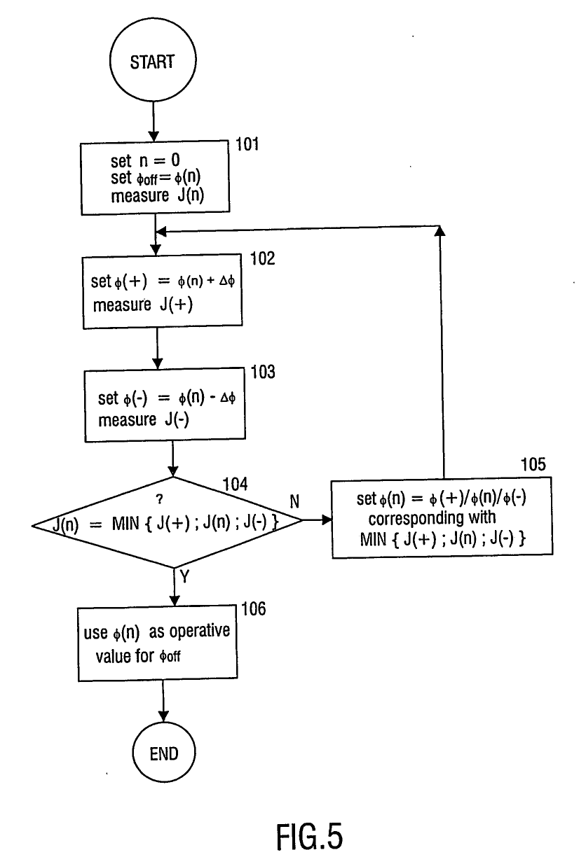

FIG. 5 is a block diagram illustrating calibration steps in a calibration procedure for a controller according to the invention;

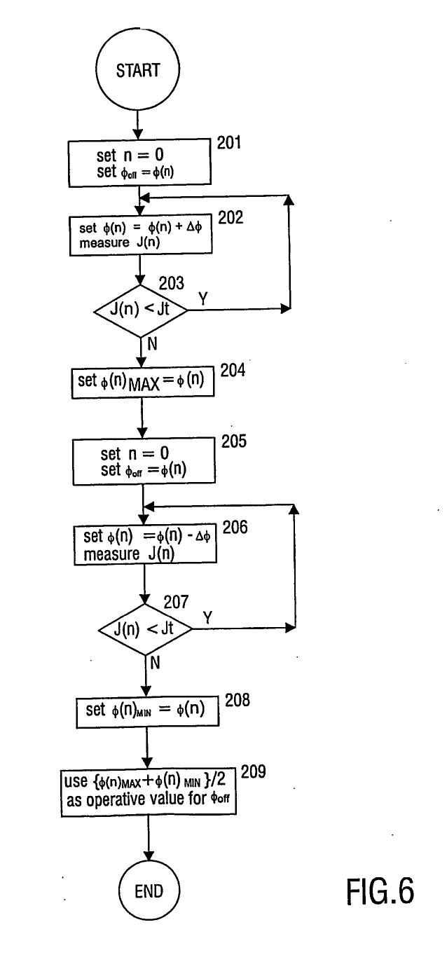

FIG. 6 is a block diagram illustrating calibration steps in another calibration procedure for a controller according to the invention.

Hereinafter, the present invention will specifically be explained for an optical disc drive for reading information from an optical disc. However, the present invention is equally applicable to an optical disc drive for writing information into a recordable optical disc.

FIG. 1 schematically shows relevant components of an optical disc drive, generally indicated with reference numeral 1. The optical disc drive 1 comprises means for receiving an optical disc 2, and for rotating the optical disc 2 at a predetermined rotational speed; for the sake of convenience, these receiving means and rotation means are not shown in FIG. 1.

The optical disc drive 1 comprises an optical pickup 3 for directing an optical beam 4 towards the optical disc, in order to scan the record tracks of the optical disc 2 as the disc 2 rotates;
for receiving a reflected beam 4′ reflected by the optical disc 2, which reflected beam 4′ is modulated in accordance with the information stored on the optical disc and read by the optical beam 4;
and for generating an electrical signal S in accordance with the optical read signal.

To achieve this, the optical pickup 3 comprises a beam generator 10, typically a laser diode. The light beam 4 generated by the light beam generator 10 is directed to the optical disc 2 via a beam splitter 11 and an optical lens system 12, typically comprising a collimator lens 13 and an objective lens 14. Light 4′ reflected by the optical disc 2 follows a path back through the optical lens system 12, but is separated from the light beam 4 coming from the laser generator 10 by the beam splitter 11, such that the major portion of the reflected light 4′ reaches a photo-detector 20. In the example shown, the optical path from optical lens system 12 to photo-detector 20 is a substantially straight line through the beam splitter 11 while the optical path from the light beam generator 10 to the optical lens system 12 makes an angle of 90° at the beam splitter 11. As will be clear to a person skilled in the art, the light beam generator 10 and the photo-detector 20 can, in principle, switch places, such that the optical path from the light beam generator 10 towards the optical lens system 12 is a straight line through the beam splitter 11 and the optical path from the optical lens system 12 to the photo-detector 20 makes an angle of 90° at the beam splitter 11.

The objective lens 14 is displaceable along the optical beam axis (z-direction), as indicated by arrow A, in order to accurately focus the optical beam 4 on the tracks of the optical disc 2. Controllable displacement means for displacing the objective lens 14 in the z-direction are generally indicated by reference numeral 30. Since such displacement means are commonly known, it is not necessary to explain the construction and operation of such displacement means in more detail here.

The displacement means 30 are controlled by a control signal Sc from a servo controller 31, which receives the output signal S of the photo-detector 20 as an input signal. Since such servo controllers 31 for controlling the displacement means 30 are commonly known, it is not necessary to explain the design and operation of such servo controllers in great detail here.

The optical pickup 3 as a whole is displaceable in the radial direction (x-direction) of the optical disc 2, as indicated by arrow B, in order to be able to follow a spiral-shaped track of the optical disc 2, or in order to jump from one track to another in the case of concentric circular tracks. Displacement means for displacing the optical pickup 3 in the radial direction (B) are generally indicated by reference numeral 40. Since such displacement means are commonly known, it is not necessary to explain the construction and operation of such displacement means in more detail here.

The radial displacement means 40 are controlled by a tracking servo controller 41, which also receives the output signal S of the photo-detector 20 as an input signal. Since such servo controllers 41 for controlling the radial displacement means 40 are commonly known, it is not necessary to explain the design and operation of such servo controllers in great detail here.

In the optical pickup 3, the focal point F of the reflected light beam 4′ is a fixed point in space, virtually independent of the axial position of the objective lens 14 as set by the lens displacement means 30. Therefore, it is important that the location of the photo-detector 20 corresponds very accurately, within very narrow tolerances, with the location of the focal point F.

The effects of a mis-positioning, i.e. a positioning error, of the photo-detector 20 will be explained with reference to FIGS. 2A-2C. FIG. 2A is a graph of jitter versus positioning error. The positioning error of the photo-detector 20 is represented by the horizontal axis. The zero location corresponds to an exact alignment of the photo-detector 20 with the focal point F. The positioning error with respect to this exact alignment is expressed in μm. The vertical axis of this graph represents jitter, as a percentage. In this context, “jitter” can be considered as being the measured variation (standard deviation σ) of the time differences between all edges of an RF signal and a clock signal generated from this RF signal.

The points in the graph correspond to measurements taken from a certain optical pickup, where the photo-detector 20 was deliberately displaced in the radial direction (x-direction) perpendicular to the optical axis. The curve connecting these measuring points represents a calculated best fit.

FIG. 2B is a graph comparable to FIG. 2A, except that now the photo-detector 20 is deliberately displaced in the track direction (y-direction) perpendicular to the optical axis.

First, reference will be made to the measuring points indicated as a diamond, and the dot-dash line connecting them, because these measuring points correspond to measurements taken from a prior art set-up. The measuring points indicated as a square, and the solid line connecting them, correspond to measurements taken from a set-up in which the present invention was implemented, in order to illustrate the advantageous effect of the present invention, and will be discussed later.

It clearly follows from the measuring points indicated as a diamond that the jitter has a minimum when the photo-detector 20 is exactly aligned with the focal point F. If the positioning error is less than 10 μm, the jitter will increase relatively little with increasing positioning error. When the positioning error is more than about 10 μm, the jitter rises quickly with increasing positioning error. Such increase of the jitter translates into poor playability of the disc.

The track controller 41 processes the output signal S from the photo-detector 20 according to the differential phase detection (DPD) method. This method is commonly known to a person skilled in the art, so that it is not necessary here to explain this method. For more information on the DPD method, reference is made to Standard ECMA-267 “120 mm DVD-Read-Only Disk”, December 1997, page 20 (section 14.1); this standard is available from website www.ecma.ch.

It suffices to say that, from this method, a DPD signal results, which has a peak to peak value which will be indicated as φ_{PP}. FIG. 2C illustrates the influence of the positioning error of the photo-detector 20 on this control signal value φ_{PP}. In FIG. 2C, the horizontal axis again represents the positioning error of the photo-detector 20 with respect to the location of the focal point F, in μm. The vertical axis represents the relative difference A of said control signal value φ_{PP} as compared to this value at the focal point F. This difference is calculated as follows.
Δ={φ(0)−φ(e)}/φ(0)×100%

In this respect it is noted that the exact value of the control signal value φ_{PP} is not relevant for the present explanation. The value φ_{PP} when the positioning error of the photo-detector 20 is zero, i.e. φ(0), is taken as a reference value. The value φ_{PP} at a certain positioning error e is indicated as φ(e).

From FIG. 2C, it clearly follows that the control signal value φ_{PP} reduces very rapidly with increasing positioning error e; this causes poor tracking of the reading spot on the disc.

Thus, FIGS. 2A-C illustrate the need for high positioning accuracy of the photo-detector 20. The tolerances in x-direction and y-direction are in the order of 10 μm.

The operation of the focus servo controller 31 will now be explained with reference to FIGS. 3A and 3B.

Typically, the photo-detector 20 is a 4-quadrant detector, i.e. the photo-detector 20 comprises four independent segments 21, 22, 23, 24, arranged according to four quadrants of a square, as schematically illustrated in FIG. 3A. Each independent detector segment 21-24 produces an electrical measuring signal S1-S4, respectively. The servo controller 31 receives these four photo-detector signals S1-S4, and generates a focus control signal Sc which is provided to the focus displacement means 30. In an equilibrium state (system in focus), the focus control signal Sc is zero, and the focus displacement means 30 leave the objective lens 14 in place. If the system is out of focus, the servo controller 31 generates its focus control signal Sc such that the displacement means 30 displace the objective lens 14 into a direction which will lead to a decrease of the focus control signal Sc.

In a typical state of the art system, the focus control signal Sc is equal to or proportional to a focal error FE, defined as
FE=(S1−S2)/LPF(S1;S2)+(S3−S4)/LPF(S3;S4)

Herein, LPF(S1;S2) and LPF(S3;S4) represent a low pass filtering of the summation of the signals S1 and S2, and a low pass filtering of the signals S3 and S4, respectively.

FIG. 3B schematically illustrates a functional block diagram of a servo controller 31 according to the state of the art. The servo controller 31 has four inputs 51, 52, 53, 54, receiving the independent detector signals S1, S2, S3, S4, respectively. The signals S1 and S2 are added in a first adder 55, whose output signal S1+S2 is passed through a first low pass filter 56. Similarly, the third and fourth input signals S3 and S4 are added in a second adder 57, whose output signal S3+S4 is passed through a second low pass filter 58.

The first and second measuring signals S1 and S2 are subtracted by a first subtractor 59. A first divider 60 divides the output signal S1-S2 from the first subtractor 59 by the output signal LPF(S1;S2) from the first low pass filter 56; the output signal of the first divider 60 is indicated as SA. Similarly, the third and fourth measuring signal S3 and S4 are subtracted by a second subtractor 61. A second divider 62 divides the output signal S3-S4 from the second divider 62 by the output signal LPF(S3;S4) from the second low pass filter 58; the output signal of the second divider 62 is indicated as SB.

The output signals SA and SB from the dividers 60 and 62 are added by a third adder 63, to provide a focal error signal FE=SA+SB

In practice, prior art servo controllers may have a design differing from the design illustrated by way of example in FIG. 3B. For instance, the low pass filters 56 and 58 may be omitted and, in principle, even the first and second adders 55 and 57 and the dividers 60 and 62 may be omitted, such that a servo controller provides an output focal error signal FE=S1−S2+S3−S4. On the other hand, if desired, some filtering may be applied to the output signals of the subtractors 59 and 61, and some filtering may be applied to the output signals of the dividers 60 and 62. The filter characteristics of such filtering, and the filter characteristics of the low pass filters 56 and 58 as illustrated, may vary in accordance with servo control design.

In any case, the design of the prior art servo controller 31 will be such that the output focal error signal FE=0 if the reflected beam 4′ is focused as a cylindrical spot on the center of the photo-detector 20, as indicated in FIG. 3A by the circle 25. In such a case, the four measuring signals S1, S2, S3, S4 will be equal to each other, such that SA=0 and SB=0.

FIG. 4 schematically illustrates a servo controller 70 according to the present invention. The servo controller 70 has four inputs 71-74 receiving the four measuring signals S1-S4 from the four independent detector segments 21-24, and an output 78 for providing a control signal Sc to the optical lens actuator 30. The servo controller 70 comprises a first stage 75, which receives the four input measuring signals S1-S4 from the four inputs 71-74, and which is designed to provide an output signal FE which equals zero if the four signals S1-S4 have equal magnitude, such as when the reflected beam 4′ is projected as a circular spot 25 on the center of the photo-detector 20, as illustrated in FIG. 3A. By way of example, the first stage 75 of the inventive servo controller 70 may be identical to a prior art servo controller 31 as illustrated in FIG. 3B.

The servo controller 70 according to the invention further has an offset input 76 receiving an offset signal φ_{off}. A subtractor 77 subtracts the offset signal φ_{off} from the error output signal FE from the first stage 75, and the result is provided at the servo controller output 78 as a control signal Sc=FE−φ_{off}.

It should be clear to a person skilled in the art that the optical lens system actuator 30, controlled by the servo control signal Sc=FE−φ_{off}, will keep the objective lens 14 in place at its current location if the control signal Sc equals zero, i.e. if the focal error signal FE equals φ_{off}. However, if φ_{off} does not equal zero, the shape of the spot of the reflected beam 4′ on the photo-detector 20 is no longer circular, but rather elongated, such as an ellipse. Typically, the longitudinal axis of this elongated shape is directed along one of the diagonals of the photo-detector 20.

Thus, the offset signal φ_{off} in the servo controller 70 introduces a deliberate focal offset error in the optical pickup 3.

Surprisingly, it has been found that the optical pickup 3 is less sensitive now to positioning errors of the photo-detector 20. This effect is also illustrated in FIGS. 2A-B. As mentioned before, FIG. 2A is a graph illustrating jitter as a function of the positional error of the photo-detector 20, for a positional error in the x-direction, and FIG. 2B is a similar graph for positional errors in the y-direction. In these graphs, measuring points indicated by a diamond represent measurements taken from a prior art set-up, i.e. without focal offset, the reflected beam 4′ being focused as a circular spot on the measuring photo-detector 20. If in the servo controller 70 the offset signal φ_{off} would be chosen to be zero, the servo behavior is completely determined by the first stage 75, i.e. identical to prior art behavior. The measuring points indicated by means of a square relate to measurements performed with focal offset, i.e. taken from an inventive servo controller 70 with an offset signal φ_{off}>0. It can clearly be recognized in FIGS. 2A and 2B that, in the case where the offset signal φ_{off}>0, the jitter is always smaller than the jitter in the comparable case without focal offset.

It has also been found that adding said offset signal φ_{off}>0 has a very advantageous effect on the influence that a positioning error has on the control signal value φ_{PP}.

In the above-mentioned measurements with the offset signal φ_{off}>0, the offset was set in accordance with an optimum value, as will be explained hereinafter. This optimum value appeared to be approximately 3 μm in the case of the experimental setup, but may be different for other setups. However, it is noted that the present invention does not only apply in the case of an optimum offset value. Advantages as described above will also be obtained if the offset value φ_{off} is close to optimum, or if the offset value φ_{off} is in the range between zero (prior art value) and the optimum value.

In principle, it would be possible that the offset value is a variable parameter. Preferably, however, the offset value φ_{off} is only determined once on start-up of the optical disc drive, and is maintained at a constant value during operation of the disc drive. A procedure for determining a useful, potentially optimum, value for φ_{off} will now be described.

FIG. 5 is a block diagram illustrating calibration steps in a calibration procedure for finding an operative value of the offset value φ_{off}. This calibration procedure can easily be performed by suitable software in the servo controller 70, as will be clear to a person skilled in the art. In the calibration procedure illustrated, a control parameter P is considered of which it is known that the offset parameter φ_{off} has an advantageous effect on this parameter P. In the following explanation, it will be assumed that this parameter P is the jitter of the photo-detector 20 output signal S. The jitter is a reflection of the quality of this detector signal S (i.e., the combination of the individual detector signals S1, S2, S3, S4). Since the servo controller 70 receives these signals, the servo controller 70 can be adapted to derive a signal representing the jitter, as will be clear to a person skilled in the art.

After start-up of the disc drive 1, in a first step 101, the offset parameter Doff will be given an initial value φ(0), which typically will be zero. For this value φ(0), the jitter will be measured, and the measured value of the jitter will be indicated as J(o).

In a second step 102, a new value φ(+) of the offset parameter φ_{off} will be calculated as φ(+)=φ(0)+Δφ, wherein Δφ is a step value having a predetermined value. For this new value φ(+), the jitter will be measured as J(+).

In a third step, a new value φ(−)=φ(0)−Δφ will be calculated, and jitter J(−) will be measured.

In a fourth step, it is determined whether J(0) has the lowest value of the set {J(−), J(0), J(+)}. If that is not the case, then, in a fifth step, the offset value φ(−) or φ(+) yielding the lowest value of jitter J(−) or J(+), respectively, will be taken as new value for further approximation steps, and the procedure continues with the second step 102. Thus, in each successive approximation cycle, the current approximation value φ(n) of the offset parameter φ_{off} is increased by the step value Δφ to yield φ(+), and is decreased by the step value to yield φ(−), and it is determined which one of these three values φ(−), φ(n), φ(+) yields the lowest jitter J(−), J(n), J(+). Each time φ(−) or φ(+) yields a better result of the jitter than φ(n), a new approximation step is performed. As soon as it turns out that the current approximation value φ(n) yields the lowest jitter value J(n), then in a sixth step 106 the current approximation value φ(n) is set as the operative value of the offset parameter φ_{off}. Then, the calibration procedure is over.

If desired, before going to step 106, the approximation procedure may be refined by decreasing the step value Δφ and continuing the approximation procedure of step 102 with this lower step value. However, in practice this will not be necessary.

Obviously, the steps 102 and 103 may change places.

In another calibration procedure, illustrated in FIG. 6, an initial value for the offset parameter φ_{off} is again set to be zero (201).

In a second step 202, the offset parameter φ_{off} is increased with a step value Δφ, and the corresponding jitter J(n) is measured.

In a next step 203, the measured jitter value J(n) is compared with a predetermined threshold value Jt. If the jitter is below this threshold, the procedure returns to the second step 202 to increase the value of the offset parameter. This stepwise increase of the offset parameter off is continued until the jitter exceeds the predetermined jitter threshold Jt, which for instance can be 15%. The corresponding offset value φ(n)_{MAX} is now memorized (204).

Then, in a second stage of the calibration process, the above steps are repeated, but now the offset value is decreased from the initial value until the jitter again exceeds the predetermined threshold value Jt. Now the current offset value φ(n)_{MIN} is memorized (208).

Then, assuming that the response characteristic of the jitter to the offset parameter φ_{off} is substantially symmetrical, the operative value for the offset parameter φ_{off} is calculated as {φ(n)_{MAX}+φ(n)_{MIN}}/2 (209).

However, other methods for calculating an operative value for the offset parameter φ_{off} are possible, too.

It should be clear to a person skilled in the art that the present invention is not limited to the exemplary embodiments discussed above, but that various variations and modifications are possible within the protective scope of the invention as defined in the appending claims.

For instance, in FIG. 4, the servo controller 70 is illustrated as a hardware implementation. However, as should be clear to a person skilled in the art, it is also possible to implement the servo controller 70 in software, as a suitably programmed microcontroller for instance. In that case, taking the offset φ_{off} into account can be easily executed by suitably adapting the software in the microcontroller. In this case, since the implementation of the present invention does not involve adding any hardware, the present invention obtains the advantageous effects as described at virtually no additional cost.

Furthermore, in the above, “jitter” is used as an example of a parameter indicative of photo-detector output signal quality, good quality corresponding to a low parameter value. The invention is, mutatis mutandis, also applicable in conjunction with other types of monitoring parameters where a good photo-detector output signal quality corresponds to a high parameter value.

Furthermore, instead of subtracting the offset signal φ_{off} from the error output signal FE, the inventive servo controller 70 may alternatively be adapted to add the offset signal φ_{OFF} to the error output signal FE.

Furthermore, the inventive servo controller 70 may have an offset input 76 for receiving an external offset signal, and the pickup 3 may be provided with a control unit programmed to perform the calibration procedure, such control unit setting the offset signal. However, it is also possible that the servo controller 70 itself is adapted to generate an internal offset signal and programmed to perform the calibration procedure; in that case, the inventive servo controller 70 does not need to have an offset input 76.

Furthermore, the inventive servo controller 70 may be adapted to provide the error output signal FE as an output signal, but it is also possible that the error output signal FE is just an intermediate calculation result inside the controller.

1. Servo controller for controlling a focus actuator in an optical pickup for an optical disc drive; the controller comprising signal inputs for receiving respective detector signals from a photo-detector of such an optical pickup;
wherein the servo controller is adapted to process the signals received at its inputs to produce a focal error signal which is zero if the signals at the inputs represent the situation of a focussed beam incident on the center of such a photo-detector;
the servo controller further being adapted to subtract an offset parameter from said focal error signal, and to provide the difference as a control output signal; or, alternatively, the servo controller further being adapted to add an offset parameter to said focal error signal, and to provide the sum as a control output signal.

2. Servo controller according to claim 1, adapted for receiving respective detector signals from a 4-quadrant photo-detector of an optical pickup;
wherein the servo controller is adapted to produce a focal error signal which is zero if the signals at the four inputs all have identical magnitude.

3. Servo controller according to claim 2, adapted to calculate the focal error signal according to the formula
FE=SA+SB,
wherein SA is proportional to the difference between the input signals received at the first and second inputs,
and wherein SB is proportional to the difference between the signals received at the third and fourth inputs.

4. Servo controller according to claim 1, adapted to perform a calibration procedure calculating an operative value for the offset parameter on start up of the servo controller, and to maintain the offset parameter constant during operation.

5. Servo controller according to claim 4, adapted to monitor, during said calibration procedure, a parameter derivable from the input signals received at the inputs and indicative of photo-detector output signal quality;
to stepwise change the value of the offset parameter and to measure the corresponding value of said parameter;
and to set the operative value for the offset parameter as the value corresponding to the best value of the said parameter.

6. Servo controller according to claim 4, adapted to monitor, during said calibration procedure, a parameter derivable from the input signals received at the inputs and indicative of photo-detector output signal quality;
to stepwise change the value of the offset parameter until the offset parameter reaches a value φ(n)_{MAX} where the value of said parameter reaches a predetermined threshold value;
to stepwise change the offset value into the other direction until the offset parameter reaches a value φ(n)_{MIN} where the value of said parameter reaches the same threshold value;
and to calculate the operative value of the offset parameter as {φ(n)_{MAX}+φ(n)_{MIN}}/2.

7. Servo controller according to claim 1, further comprising an offset input for receiving the offset signal.

8. Optical pickup for an optical disc drive comprising:
a photo-detector;
an objective lens mounted displaceably with respect to the photo-detector;
an optical displacement actuator for displacing the objective lens;
a servo controller according to any one of the previous claims, receiving an output signal from the photo-detector as input signal, and generating a control signal for controlling the actuator on the basis of said photo-detector output signal.

9. Optical disc drive, for optically reading information from an optical disc and/or writing optical information into an optical disc, comprising an optical pickup according to claim 8.
